(19) United States
(12) Patent Application Publication
(10) Pub. No.: US 2022/0030885 A1
(43) Pub. Date: Feb. 3, 2022

(54) PRODUCTION METHOD FOR DOUGH FOR BREADS

(71) Applicant: J-OIL MILLS, INC., Tokyo (JP)

(72) Inventors: Keiko YAMAKU, Tokyo (JP); Yuya NAGAHATA, Tokyo (JP); Hirofumi NOGAMI, Tokyo (JP); Sanshiro SAITO, Tokyo (JP)

(21) Appl. No.: 17/276,174

(22) PCT Filed: Sep. 27, 2019
(86) PCT No.: PCT/JP2019/038067

§ 371 Date: Mar. 15, 2021

(30) Foreign Application Priority Data
Sep. 28, 2018 (JP) 2018-183572
Jun. 24, 2019 (JP) 2019-116246

(51) Int. Cl. A21D 2/18; A21D 2/16; A21D 8/02

(52) U.S. Cl. CPC A21D 2/186; A21D 8/02; A21D 2/165

(57) ABSTRACT

The invention relates to a production method for dough for breads, a production method for breads, a method for preventing a moist feeling of breads from decreasing, and a starch composition to be added to dough in a middle stage of mixing in producing dough for breads. According to the invention, dough for breads is produced by a method comprising: a step of preparing a starch composition containing 50% by mass to 97% by mass of pregelatinized starch and 3% by mass to 50% by mass of an edible oil and fat; a step of adding the starch composition to the dough in a middle stage of mixing; and a step of further kneading the dough in the middle stage of mixing to which the starch composition is added. According to preferred embodiments of the invention, breads which can maintain its moist feeling can be provided.

### TECHNICAL FIELD

The present invention relates to a production method for dough for bread or the like (“breads”), a production method for breads, a method for preventing a moist feeling of breads from decreasing, and a starch composition to be added to dough in a middle stage of mixing in producing dough for breads.

### BACKGROUND ART

Pregelatinized starch has been widely used in the food field as a thickener and a shape retainer for a long time because it has excellent physical properties such as cold water solubility, water absorption, and adhesiveness. Recently, attention has also been paid to the texture improving effect of pregelatinized starch, and pregelatinized starch is also used in dough for breads.

When pregelatinized starch is used for breads, it tends to become dry over time, and because the water absorption is too high, the dough containing pregelatinized starch becomes sticky and the workability deteriorates, which are disadvantageous. However, it is known that these disadvantages can be eliminated by using pregelatinized starch in combination with edible oils and fats.

For example, JP 9-233993 A (1997) (Patent Literature 1) discloses that breads with a soft texture can be obtained without using an emulsifier by using a mixture of pregelatinized starch, a glycolytic enzyme, and an edible oil and fat.

In addition, JP 2001-120195 A (Patent Literature 2) discloses that an oil-and-fat pregelatinized starch having a predetermined degree of oil-and-fat separation and adhesion, which is obtained by heating a starch slurry in the coexistence of an oil and fat, is used such that soft and moist breads with favorable meltability in mouth can be obtained with excellent workability due to non-stickiness of dough.

### CITATION LIST

### Patent Literature

Patent Literature 1: JP 9-233993 A (1997)

Patent Literature 2: JP 2001-120195 A

### SUMMARY OF INVENTION

### Technical Problem

As described above, it is known that by using pregelatinized starch in combination with edible oils and fats, it is possible to achieve excellent workability due to non-stickiness of dough and improve the texture of breads to be soft and moist. However, with the conventional methods, it may be difficult to maintain the soft and moist texture of breads for a long time.

Under such circumstances, it is desired to provide breads which does not become dry over time and can maintain the soft and moist texture for a long time.

### Solution to Problem

The present invention provides a production method for dough for bread or the like, a production method for breads, a method for preventing a moist feeling of breads from decreasing, and a starch composition to be added to dough in a middle stage of mixing in producing dough for breads as described below.

[1] A production method for dough for breads, the method comprising.

preparing a starch composition containing 50% by mass to 97% by mass of pregelatinized starch and 3% by mass to 50% by mass of an edible oil and fat;

adding the starch composition to the dough in a middle stage of mixing; and

further kneading the dough in the middle stage of mixing to which the starch composition is added.

[2] The production method according to [1], wherein the starch composition is obtained by pregelatinizing a starch slurry containing the edible oil and fat.

[3] The production method according to [1], wherein the starch composition is obtained by mixing the pregelatinized starch and the edible oil and fat.

[4] The production method according to any one of [1] to [3], wherein the amount of the starch composition added is 1 part by mass to 20 parts by mass with respect to 100 parts by mass of the total amount of flour in the dough for breads.

[5] The production method according to any one of [1] to [4], further comprising adding an oil-and-fat composition to the dough in the middle stage of mixing.

[6] The production method according to [5], wherein the oil-and-fat composition is a water-in-oil emulsified oil-and-fat composition.

[7] The production method according to [5] or [6], wherein the amount of the oil-and-fat composition added is 1 part by mass to 100 parts by mass with respect to 100 parts by mass of the total amount of flour in the dough for breads.

[8] A production method for breads, the method comprising: heating the dough for breads obtained by the production method according to any one of [1] to [7].

[9] A method for preventing a moist feeling of breads from decreasing, the method is characterized by adding a starch composition containing 50% by mass to 97% by mass of pregelatinized starch and 3% by mass to 50% by mass of an edible oil and fat to dough in a middle stage of mixing in obtaining dough for the breads. [10] A starch composition to be added to dough in a middle stage of mixing in producing dough for breads, the composition comprising 50% by mass to 97% by mass of pregelatinized starch and 3% by mass to 50% by mass of an edible oil and fat.

### Advantageous Effects of Invention

According to the present invention, a production method for dough for breads is provided. The present invention also provides a production method for breads, and further provides a method for preventing a moist feeling of breads from decreasing, and a starch composition to be added to dough in a middle stage of mixing in producing dough for breads.

According to the present invention, breads which can maintain its moist feeling can be provided by producing dough for breads using the production method for dough for breads of the present invention. According to preferred embodiments of the invention, bread or the like (breads) which is soft and moist and has chewy feeling for the crumb, and can maintain a texture with favorable meltability in mouth can be provided.

### DESCRIPTION OF EMBODIMENTS

Hereinafter, a production method for dough for breads, a production method for breads, a method for preventing a moist feeling of breads from decreasing, and a starch composition to be added to dough in a middle stage of mixing in producing dough for breads will be described.

### 1. Production Method for Dough for Breads

The production method for dough for breads of the present invention is characterized by:

a step of preparing a starch composition containing 50% by mass to 97% by mass of pregelatinized starch and 3% by mass to 50% by mass of an edible oil and fat (hereinafter also referred to as “preparation step”);

a step of adding the starch composition to the dough in a middle stage of mixing (hereinafter also referred to as “starch composition addition step”); and

a step of further kneading the dough in the middle stage of mixing to which the starch composition is added (hereinafter also referred to as “kneading step”).

The production method for dough for breads of the present invention is intended to improve a texture of breads to be obtained by adding a starch composition containing predetermined amounts of pregelatinized starch and an edible oil and fat to dough in a middle stage of mixing, but not blending it together with other ingredients of dough for breads in an early stage of mixing, and carrying out kneading. Hereinafter, each step will be described.

### (1) Preparation Step

In the preparation step, a starch composition containing 50% by mass to 97% by mass of pregelatinized starch and 3% by mass to 50% by mass of an edible oil and fat is prepared.

The pregelatinized starch used in the present invention is a starch obtained by pregelatinization treatment. The pregelatinized starch is preferably one or more selected from starches obtained by pregelatinizing 1) and 2) below.

1) Unprocessed starch selected from the group consisting of corn starch, sweet potato starch, potato starch, tapioca starch, sago starch, wheat starch, and rice starch

2) Processed starch obtained by subjecting the unprocessed starch to one or more processing treatments selected from the group consisting of monoesterification, etherification, cross-linking, oxidation, acid treatment, alkali treatment, and enzyme treatment

The term “pregelatinization treatment” used herein refers to a treatment including heat-gelatinization of a starch slurry obtained by mixing a starch selected from the unprocessed starch and the processed starch with water and drying of the gelatinized slurry. If necessary, a pulverization treatment may be performed after the treatment of drying. Specifically, for heat-gelatinization included in the pregelatinization treatment, a method using an apparatus such as “ONLATOR” (registered trademark), a jet cooker, or an extruder may be selected, and for drying included in the pregelatinization treatment, a method using an apparatus such as a drum dryer, a spray dryer, or a blower dryer may be selected. In addition, in a case in which a drum dryer is used, it is possible to perform heat-gelatinization and drying in an integrated manner by applying the starch slurry directly to the drum. The pregelatinized starch after the drying treatment usually contains 2% by mass to 10% by mass of water.

Examples of the unprocessed starch include plant-derived starches. Specific examples of plants as the origin of the unprocessed starch include regular corn (dent corn), glutinous corn (waxy corn), high amylose corn, non-glutinous rice, glutinous rice, wheat, sweet potato, potato, cassava, and sago palm. Regular corn, glutinous corn, high amylose corn, non-glutinous rice, glutinous rice, wheat, potato, and cassava are preferable, regular corn, glutinous corn, high amylose corn, glutinous rice, potato, and cassava are more preferable, and glutinous corn, glutinous rice, and cassava arc still more preferable.

Examples of the processed starch include starches obtained by subjecting the unprocessed starch to one or more processing treatments including monoesterification such as acetylation or phosphate monoesterification, cross-linking such as phosphoric acid cross-linking or adipic acid cross-linking, etherification such as hydroxypropyiation, oxidation, acid treatment, alkali treatment, and enzyme treatment. Starches obtained by performing one or more processing treatments including monoesierification, cross-linking, etherification, oxidation, and acid treatment are preferable. Starches obtained by performing one or more processing treatments including monoesterification, cross-linking, etherification, and acid treatment are more preferable. Acetylated starch, distarch phosphate, acetylated distarch phosphate, hydroxypropyl starch, hydroxypropyl distarch phosphate, or acid-treated starch is still more preferable. Distarch phosphate, acetylated distarch phosphate, hydroxypropyl distarch phosphate, or acid-treated starch is even more preferable.

The type and combination of the starches can be appropriately selected according to the purpose and use of breads to be obtained.

The content of pregelatinized starch in the starch composition is in a range of 50% by mass to 97% by mass with respect to the total mass of the starch composition. When the content of the pregelatinized starch is within the above range, the effect of prolonging the moist texture of breads obtained by heating the dough for breads is likely to be obtained.

The edible oil and fat used in the present invention is not particularly limited as long as it is an oil and fat used for edible use. Examples of a raw material oil and fat used for the edible oil and fat include: vegetable oils and fats such as soybean oil, rapeseed oil, corn oil, cottonseed oil, rice oil, sunflower oil, safflower oil, sesame oil, olive oil, palm oil, palm kernel oil, and coconut oil; animal oils and fats such as fish oil, lard, beef tallow, and milk fat; medium chain fatty acid triglyceride; and processed oils and fats processed by one or more processing techniques selected from the group consisting of transesterification, hydrogenation, and fractionation. The edible oil and fat may contain one kind or two or more kinds of the raw material oils and fats.

The iodine value of the edible oil and fat is preferably 0 to 100, more preferably 0 to 90, still more preferably 0 to 80, and even more preferably 0 to 70. When the iodine value of the edible oil and fat is within the above range, the effect of prolonging the moist texture of breads obtained by heating the dough for breads is likely to be obtained.

The content of the edible oil and fat in the starch composition is in a range of 3% by mass to 50% by mass with respect to the total mass of the starch composition. It is preferably in a range of 4% by to 48% by mass, more preferably 5% by mass to 44% by mass, and still more preferably 6% by mass to 40% by mass. When the content of the edible oil and fat is within the above range, the effect of prolonging the moist texture of breads obtained by heating the dough for breads is likely to be obtained.

In preferred embodiments of the present invention, the total content of the edible oil and fat and the pregelatinized starch in the starch composition is preferably in a range of 90% by mass to 100% by mass, more preferably 95% by mass to 100% by mass, still more preferably 98% by mass to 100% by mass, even more preferably 99% by mass to 100% by mass, even more preferably 99.5% by mass to 100% by mass, even more preferably 99.7% by mass to 100% by mass, and most preferably 99.9% by mass to 100% by mass with respect to the total mass of the starch composition. When the total content of the edible oil and fat and the pregelatinized starch is within the above range, the effect of prolonging the soft and moist texture of breads obtained by heating the dough for breads is likely to be obtained.

The starch composition may contain other components, for example, emulsifiers such as monoglycerol fatty acid ester, organic acid monofatty acid glyceride, polyglycerol fatty acid ester, polyglvcerol condensed ricinoieic acid ester, sorbitan fatty acid ester, propylene glycol fatty acid ester, and sucrose fatty acid ester, colorants, and flavors as long as they do not interfere with the object and effect of the present invention.

According to preferred embodiments of the present invention, the content of water (excluding water in pregelatinized starch) in the starch composition is 0% by mass to 1% by mas, preferably 0% by mass to 0.5% by mass, more preferably 0% by mass to 0.3% by mass, and still more preferably 0% by mass to 0.1% by mass. By setting the amount of water in the starch composition within the above range, it becomes easy to uniformly mix the edible oil and fat and the pregelatinized starch when preparing the starch composition, and therefore, the stickiness of dough for breads can be suppressed, which makes it easy to handle the dough when taking out the dough from a mixing container such as a mixing bowl or upon dough dividing and dough moulding.

The starch composition used in the present invention may be obtained by pregelatinizing a starch slurry containing an edible oil and fat, or it may be obtained by mixing pregelatinized starch and an edible oil and fat.

For example, in a case in which a starch slurry containing an edible oil and fat is pregelatinized to obtain a starch composition, when performing pregelatinization treatment, a starch composition can be obtained by adding a starch selected from unprocessed starch and processed starch to water and further mix an edible oil and fat therewith so as to prepare a starch slurry and pregelatinize the starch slurry. The method of pregelatinization treatment is as described above. Alternatively, pregelatinized starch may be added to water and an edible oil and fat may be further mixed therewith so as to prepare a starch slurry.

In a case in which a starch composition is obtained by the above method, the content of the pregelatinized starch in the starch composition is preferably 60% by mass to 97% by mass, more preferably 80% by mass to 96% by mass, and still more preferably 90% by mass to 95% by mass with respect to the total mass of the starch composition. In addition, in a case in which a starch composition is obtained by the above method, the content of the edible oil and fat in the starch composition is preferably 3% by mass to 40% by mass, more preferably 4% by mass to 20% by mass, and still more preferably 5% by mass to 10% by mass with respect to the total mass of the starch composition.

For example, in a case in which pregelatinized starch and an edible oil and fat are mixed so as to obtain a starch composition, it can be produced by preparing a fluid oil phase containing an edible oil and fat, adding this oil phase to pregelatinized starch, and mixing them.

The solid fat content of the edible oil and fat used above at 20° C. is preferably 3% to 97%, more preferably 5% to 95%, still more preferably 5% to 93%, even more preferably 10% to 93%, even more preferably 15% to 93%, and particularly preferably 20% to 93%. For example, it may be 7% to 80% or 7% to 70%. The solid fat content of the edible oil and fat at 35° C. is preferably 0% to 60%, more preferably 0% to 50%, even more preferably 0% to 40%, even more preferably 2% to 38%, particularly preferably 0% to 25%, and more particularly preferably 3% to 25%. The solid fat content of the edible oil and fat can be measured in accordance with METHOD I described in AOCS Official Method Cd 16b-93.

In a case in which a starch composition is obtained by the above method, the content of the pregelatinized starch in the starch composition is preferably 50% by mass to 94% by mass, more preferably 54% by mass to 92% by mass, and still more preferably 60% by mass to 90% by mass with respect to the total mass of the starch composition. In addition, in a case in which a starch composition is obtained by the above method, the content of the edible oil and fat in the starch composition is preferably 6% by mass to 50% by mass, more preferably 8% by mass to 46% by mass, and still more preferably 10% by mass to 40% by mass with respect to the total mass of the starch composition.

Specifically, first, a fluid oil phase containing an edible oil and fat is prepared. In a case in which the edible oil and fat is in a solid state, a fluid oil phase can be obtained by heating to an appropriate temperature, for example, 45° C. to 80° C. In a case in which the edible oil and fat is fluid at room temperature, it may be used as it is as an oil phase, or in order to maintain the oil phase in a more stable state, it may be heated as necessary to an appropriate temperature, for example, 45° C. to 80° C. for use.

Next, the prepared oil phase is added to the pregeiatinized starch and mixed. When adding the oil phase to the pregelatinized starch and mixing them, in order to achieve uniform mixing, it is preferable to keep the oil phase in a stable state by heating as necessary to, for example, 45° C. to 80° C.

The starch composition can be obtained as described above. It is preferable not to add water to the starch composition in order to easily suppress the stickiness of dough for breads.

### (2) Starch Composition Addition Step

In a starch composition addition step, the starch composition is added to dough in a middle stage of mixing.

Here, mixing includes an early stage of mixing, a middle stage of mixing, and a late stage of mixing.

The early stage of mixing is a stage in which ingredients of dough for breads are dispersed and mixed at a low speed, and the flour gradually absorbs water and becomes a mass.

The middle stage of mixing is a stage in which the mixing speed is changed to a medium speed for kneading such that the dough becomes sticky and becomes more elastic while repeatedly sticking to and separating from the edge of the bowl so as to be combined, thereby creating a skeleton of dough for breads.

The late stage of mixing is a stage in which the mixing speed is set to a medium or high speed for further kneading such that the dough becomes more elastic and moves away from the edge of the bowl, and the surface thereof changes to a smooth and slightly dry state, thereby finishing dough for breads.

In the case of the sourdough (naturally leavened bread) method such as the sponge dough method, the water roux method, or the Polish method, the production method for breads includes two or more mixing steps including a step of preparing sourdough and a main kneading step of mixing the sourdough with ingredients of breads other than the sourdough. In this regard, the starch composition addition step may be a step of adding the starch composition to dough in the middle stage of mixing in either or both of the step of preparing sourdough and the main kneading step. The starch composition addition step is preferably a step of adding the starch composition to dough in the middle stage of mixing in the main kneading step.

Here, bread mixers generally include 3-speed variable stage type bread mixers and 4-speed variable stage type bread mixers. In the case of 3-speed variable stage type bread mixers, there are low speed (1st speed), medium speed (2nd speed), and high speed (3rd speed) stages in an ascending order of rotating speed. In the case of 4-speed variable stage type bread mixers, there are low speed (1st speed), medium-low speed (2nd speed), medium-high speed (3rd speed), and high speed (4th speed) stages in an ascending order of rotating speed. The medium-low speed and medium-high speed stages correspond to the medium speed stage.

In the production method for dough for breads of the present invention, the starch composition is added to dough in the middle stage of mixing after the ingredients of the dough for breads are sufficiently dispersed and mixed in the early stage of mixing. Accordingly, the effect of prolonging the moist texture of breads obtained by heating the dough for breads is likely to be obtained. Further, the effect of prolonging softness, chewy feeling for the crumb, and favorable meltability in mouth is likely to be obtained. In addition, according to preferred embodiments of the present invention, also in a case in which dough for breads is stored by freezing or refrigerating for a certain period of time before heating, the effect of prolonging the moist texture of breads obtained by heating the dough for breads is likely to be obtained.

The ingredients of dough for breads may be appropriately selected according to the type of bread and the target product, and is not particularly limited. Examples thereof include Hour such as wheat flour, rye flour, barley flour, rice flour, or soybean flour, and water, as well as a leavening agent, a salt, an emulsifier, a sugar, eggs, and yeast.

The wheat flour is not particularly limited as long as it is used in bakery products, and for example, bread flour, all-purpose flour, cake flour, and combinations thereof can be used, but it is preferable to use bread flour.

The rice flour is not particularly limited as long as it is used in bakery products, and for example, non-glutinous rice Hour can be used.

The soybean flour is not particularly limited as long as it is used in bakery products, and for example, whole-fat soybean flour, defatted soybean flour, and combinations thereof can be used.

The water is not particularly limited as long as it is used in bakery products, and examples thereof include natural water and tap water. Further, a water-containing liquid such as milk, soymilk, or fruit juice may be used.

The leavening agent is not particularly limited as long as it is used in bakery products, and for example, sodium bicarbonate, potassium bicarbonate, sodium aluminum phosphate, acidic sodium pyrophosphate, sodium aluminum sulfate, monocalcium phosphate, and combinations thereof can be used.

Examples of the emulsifier that can be used include lecithin, monoglycerol fatty acid ester, organic acid monofatty acid glyceride, polyglycerol fatty acid ester, polyglycerol condensed ricinolcic acid ester, sorbitan fatty acid ester, propylene glycol fatty acid ester, sucrose fatty acid ester, and combinations thereof as long as they do not interfere with the object and effect of the present invention.

The sugar is not particularly limited as long as it is used in bakery products, and monosaccharides such as glucose, fructose, and high-fructose corn syrup, disaccharides such as sugar, maltose, and trehalose, oligosaccharides, reduced starch digests, honey, sugar honey, maple syrup, and combinations thereof can be used.

In addition to the above, ingredients of dough for breads may include enzymes, dairy products, oils and fats, spices, alcoholic beverages, flavors, flavor improvers, sweeteners, dietary fibers, active gluten, thickening polysaccharides, cocoa powder, and vegetable powder.

The ingredients of dough for breads and the blending amounts thereof may be appropriately selected according to the type of bread and the target product.

The amount of the starch composition added may be appropriately selected according to the type of bread and the target product, and is not particularly limited. However, it is preferably 1 part by mass to 20 parts by mass, more preferably 1.5 parts by mass to 15 parts by mass, still more preferably 2 parts by mass to 15 parts by mass, even more preferably 2 parts by mass to 10 parts by mass with respect to 100 parts by mass of the total amount of flour in dough for breads. Here, the “flour” is not particularly limited as long as it is made by grinding grains into a powder, and examples thereof include wheat flour, rye flour, barley flour, rice flour, and soybean flour. Starch and gluten are not included in flour.

### (3) Oil-and-Fat Composition Addition Step

The production method for dough for breads of the present invention may further include a step of adding an oil-and-fat composition to dough in a middle stage of mixing (hereinafter also referred to as “oil-and-fat composition addition step”).

The oil-and-fat composition addition step may be carried out before, after, or at the same time as the starch composition addition step. However, it is preferable to add the starch composition and the oil-and-fat composition to the dough in the middle stage of mixing at the same time from the viewpoints of facilitating obtaining dough for breads in which the starch composition and the oil-and-fat composition are uniformly mixed and also facilitating obtaining the effect of prolonging the moist texture of breads made by heating the dough.

The oil-and-fat composition is not particularly limited as long as it contains an edible oil and fat. As the edible oil and fat, the same one as exemplified in the starch composition can be used. In addition, the oil-and-fat composition can contain an oil-soluble component together with an edible oil and fat. Examples of the oil-soluble component include tocopherols, colorants, flavors, and emulsifiers.

According to preferred embodiments of the present invention, a water-in-oil emulsified composition such as butter, margarine, and fat spread can also be used as the oil-and-fat composition. The water-in-oil emulsified composition can contain a non-oil-soluble component in the aqueous phase, and is therefore suitable for making flavorful breads. Examples of the non-oil-soluble component include skim milk powder, whole fat powder milk, condensed milk, salts, sugars, and various extracts. The water-in-oil emulsified composition may be one in which an emulsifier such as lecithin or monoglycerol fatty acid ester is used.

The amount of the oil-and-fat composition to be added to dough in the middle stage of mixing may be appropriately selected according to the type of bread and the target product, and is not particularly limited. However, it is preferably 1 part by mass to 100 parts by mass, more preferably 2 parts by mass to 50 parts by mass, and still more preferably 3 parts by mass to 30 parts by mass with respect to 100 parts by mass of the total amount of flour in dough for breads.

### (4) Kneading Step

In the kneading step, the dough in the middle stage of mixing to which the starch composition and optionally the oil-and-fat composition are added is further kneaded so as to finish dough for breads. In the production method for dough for breads of the present invention, the kneading step corresponds to the late stage of mixing. The degree of kneading may be appropriately adjusted according to the desired breads, but it is preferable to knead dough until the dough is sufficiently combined when the dough is partially taken and stretched.

The mixing time and mixing temperature may be appropriately selected according to the type of bread and the target product. The mixing time is, for example, 1 minute to 30 minutes, and the mixing temperature is, for example, 0° C. to 40° C.

The final stage of mixing may be appropriately selected according to the type of bread and the target product. The obtained dough for breads may be divided into appropriate sizes and molded if necessary. It may also be fermented. Fermentation conditions may be appropriately selected according to the type of bread and the target product.

According to preferred embodiments of the present invention, by producing dough for breads by the production method for dough for breads of the present invention, it is possible to obtain bread or the like (breads) which is moist and soft and has chewy feeling for the crumb and a texture with favorable meltability in mouth. According to further preferred embodiments of the present invention, such texture and feeling can be prolonged. In particular, according to the present invention, The moist feeling of the obtained bread can be prolonged for a long time.

### 2. Production Method for Breads

The production method for breads of the present invention is characterized by including a step of heating dough for breads obtained in “1. Production Method for Dough for Breads.”

The term “heating” used herein refers to heating at. for example, 100° C. to 300° C., and includes processes such as frying and steaming in addition to normal baking. Further, other ingredients such as filling materials and topping materials may be added to dough for breads before heating, and the dough can be heated together with these other ingredients so as to obtain breads. Alternatively, breads may be obtained in combination with other ingredients such as these filling materials and lopping materials after heating. In addition, the oil-and-fat composition may be mixed into dough for breads in such a way to form layers before heating.

Examples of breads (bread or the like) obtained by the production method of the present invention include sandwich bread, bread rolls, Danish pastry, croissants, yeast doughnuts, fried bread, steamed bread, rice flour bread, Chinese steamed buns, pizza, sweet buns, brioche, and other buns. According to preferred embodiments of the present invention, bread or the like (breads) which is moist and soft and has chewy feeling for the crumb and a texture with favorable meltability in mouth can be obtained. According to further preferred embodiments of the present invention, such texture and feeling can be prolonged. In particular, according to the present invention, the moist feeling of the obtained bread can be prolonged for a long time.

3. Method for Preventing Moist Feeling of Breads from Decreasing

The method for preventing a moist feeling of breads from decreasing of the present invention is characterized by adding a starch composition containing 50% by mass to 97% by mass of pregeiatinized starch and 3% by mass to 50% by mass of an edible oil and fat to dough in a middle stage of mixing in a step of obtaining dough for the breads.

Regarding the starch composition and its addition amount, as well as dough in the middle stage of mixing, those as exemplified in “1. Production Method for Dough for Breads” above can be used. Breads can be obtained with the obtained dough for breads in the same manner as exemplified in “2. Production Method for Breads” above.

The moist feeling of breads tends to decrease over time after production of breads, which results in a dry texture. However, according to this method, the moist feeling of breads can be prevented from decreasing. The moist feeling can be evaluated by comparison with breads produced under the same conditions as a control example except that the starch composition is kneaded together with the other ingredients of dough for breads or by comparison with breads produced under the same conditions except that the starch composition is not used.

### 4. Starch Composition

The starch composition of the present invention is a starch composition to be added to dough in the middle stage of mixing in producing dough for breads, which is characterized by containing 50% by mass to 97% by mass of pregelatinized starch and 3% by mass to 50% by mass of an edible oil and fat.

Regarding the starch composition and its addition amount, as well as dough in the middle stage of mixing, those as exemplified in “1. Production Method for Dough for Breads” above can be used. In addition, the production method for dough for breads is also the same as described in “1. Production Method for Dough for Breads” above.

According to preferred embodiments of the present invention, bread or the like (breads) which is moist and soft and has chewy feeling for the crumb and a texture with favorable meltability in mouth can be obtained by adding the starch composition of the present invention to dough in the middle stage of mixing. According to further preferred embodiments of the present invention, such texture arid feeling can be prolonged. In particular, according to the present invention, the moist feeling of the obtained bread can be prolonged for a long time.

### EXAMPLES

The present invention will be described in more detail with reference to the following Examples, however, the present invention is not limited to these Examples.

### (1) Pregelatinized Starch

Pregelatinized starch 1: Prepared by the method of (1-1)

Pregelatinized starch 2: Pregelatinized hydroxypropyl distarch phosphate waxy corn starch (“JELCALL (registered trademark) G-α” manufactured by J-OIL MILLS)

Pregelatinized starch 3: Pregelatinized distarch phosphate potato starch (“BAKEUP (registered trademark) B-α” manufactured by J-OIL MILLS)

Pregelatinized starch 4: Prepared by the method of (1-2)

### (1-1) Preparation of pregelatinized Starch 1

Pregelatinized starch 1 was prepared according to the following method.

To 200 parts by mass of water (50° C.), 100 parts by mass of acetylated distarch phosphate tapioca starch (“ACTBODY (registered trademark) ATP-25” manufactured by J-OIL MILLS) was added and mixed with stirring, thereby preparing a starch slurry. The prepared starch slurry was gelatinized with a heat transfer apparatus “ONLATOR” (registered trademark) (outlet temperature: 100° C.) to prepare a paste solution. This paste was immediately spread thinly on a drum dryer, heated at 150° C., dried, and then pulverized with a pulverizer, thereby obtaining pregelatinized starch 1.

### (1-2) Preparation of Pregelatinized Starch 4

Pregelatinized starch 4 was prepared according to the following method.

High amylose corn starch was suspended in water to prepare a 35.6% (w/w) slurry, and then the slurry was heated to 50° C. A hydrochloric acid aqueous solution prepared at 4.25 N was added thereto with stirring in an amount of 1/9 times the mass ratio of the slurry such that a reaction was started. After the reaction for 16 hours, the mixture was neutralized with 3% NaOH, washed with water, dehydrated, and dried, thereby obtaining acid-treated high amylose corn starch.

Regular corn starch (79% by mass), acid-treated high amylose corn starch obtained by the above method (20% by mass), and calcium carbonate (1% by mass) were mixed in a bag until the resulting mixture became sufficiently uniform. The mixture was pressurized and heated under the following conditions using a biaxial extruder (“KEI-45” manufactured by KOWA KOGYO Inc.).

Raw material supply: 450 g/minute

Water added: 17% by mass

Barrel temperature: 50° C., 70° C., and 100° C. from the raw material inlet to the outlet

Outlet temperature: 100° C. to 110° C.

Screw rotation speed: 250 rpm

The pregelatinized product thus obtained by the extruder treatment was dried at 110° C. to adjust the water content to 10% by mass. The dried pregelatinized product was pulverized with a desktop cutter crusher and sieved with a JIS-Z8801-1 standard sieve. The sieved pregelatinized products were mixed at the following blending ratios, thereby obtaining pregelatinized starch 4.

Aperture size: 1.4 mm pass. Aperture size: 0.5 mm on: 20% by mass

Aperture size: 0.5 mm pass, Aperture size: 0.1 mm on: 75% by mass

Aperture size: 0.1 mm pass: 5% by mass

### (2) Preparation of Starch Composition

Starch compositions 1-1 to 1-3, starch compositions 2 to 8, and 91% oil-and-fat-blended pregelatinized starch and margarine-blended pregelatinized starch were prepared according to the following methods, respectively.

### (2-1) Starch Composition 1-1

To 200 parts by mass of water (50° C.), 94 parts by mass of acctylated distarch phosphate tapioca starch (“ACTBODY” (registered trademark) ATF-25) was added and mixed with stirring, thereby preparing a starch slurry. Six (6) parts by mass of shortening (“Facier” manufactured by J-OIL MILLS; edible oil and fat (iodine value: 66; solid fat content at 20° C.: 25%; solid fat content at 35° C.: 4%) content: 100% by mass; water content; less than 0.1% by mass) fluidized at 50° C. was further added thereto, and stirred for uniform dispersion, during which the prepared starch slurry was gelatinized with a heat transfer apparatus “ONLATOR” (registered trademark) (outlet temperature; 100° C.) to prepare a paste solution. This paste was immediately spread thinly on a drum dryer, heated at 150° C., dried, and then pulverized with a pulverizer, thereby obtaining a starch composition 1-1.

### (2-2) Starch Composition 1-2

To 200 parts by mass of water (50° C.), 94 parts by mass of glutinous rice was added and mixed with stirring, thereby preparing a starch slurry. Six (6) parts by mass of shortening fluidized at 50° C. was further added thereto, and stirred for uniform dispersion, during which the prepared starch slurry was gelatinized with a heat transfer apparatus “ONLATOR” (registered trademark) (outlet temperature; 100° C.) to prepare a paste solution. This paste was immediately spread thinly on a drum dryer, heated at 150° C., dried, and then pulverized with a pulverizer, thereby obtaining a starch composition 1-2.

### (2-3) Starch Composition 1-3

A mixed oil and fat was prepared by mixing 70 parts by mass of palm kernel oil and 30 parts by mass of palm oil. The mixed oil and fat was hydrogenated with a nickel catalyst, thereby obtaining an extremely hydrogenated oil. After removing the nickel catalyst from the extremely hydrogenated oil. a bleaching treatment was performed, thereby obtaining a bleached oil. To 100 parts by mass of this bleached oil, 0.3 parts by mass of sodium methoxide was added as a catalyst, and the mixture was stirred at 80° C. and a degree of vacuum of 2.7 kPa for 60 minutes, during which a random transesterification reaction was carried out. After the transesterification reaction, the reaction product was washed with water, bleached, and deodorized, thereby obtaining oil and fat A (iodine value; 0; solid fat content at 20° C.: 91%; solid fat content at 35° C.: 36%; water content: less than 0.1% by mass).

To 200 parts by mass of water (50° C.), 90 parts by mass of hydroxypropyl distarch phosphate waxy corn starch (“JELCALL A-18” manufactured by J-OIL MILLS) was added and mixed with stirring, thereby preparing a starch slurry. Ten (10) parts by mass of the oil and fat A fluidized at 50° C. was further added thereto, and stirred for uniform dispersion, during which the prepared starch slurry was gelatinized with a heat transfer apparatus “ONLATOR” (registered trademark) (outlet temperature: 100° C.) to prepare a paste solution. This paste was immediately spread thinly on a drum dryer, heated at 150° C., dried, and then pulverized with a pulverizer, thereby obtaining a starch composition 1-3.

### (2-4) Starch Composition 2

Twenty (20) parts by mass of shortening was heated to 50° C. so as to be fluidized. and this was mixed with 80 parts by mass of the pregelatinized starch 1 prepared in (1-1) with a mixer, thereby obtaining a starch composition 2.

### (2-5) Starch Composition 3

A starch composition 3 was obtained in the same manner as the starch composition 2 except that the amount of shortening was changed to 40 parts by mass, and the amount of the pregelatinized starch 1 was changed to 60 parts by mass.

### (2-6) Starch Composition 4

A starch composition 4 was obtained in the same manner as the starch composition 2 except that the pregelatinized starch 1 was replaced with the pregelatinized starch 2.

### (2-7) Starch Composition 5

A starch composition 5 was obtained in the same manner as the starch composition 2 except that the amount of shortening was changed to 46 parts by mass, and 80 parts by mass of the pregelatinized starch 1 was changed to 54 parts by mass of the pregelatinized starch 3.

### (2-8) Starch Composition 6

A starch composition 6 was obtained in the same manner as the starch composition 2 except that the amount of shortening was changed to 40 parts by mass, and the pregelatinized starch 1 was replaced with the pregelatinized starch 4.

### (2-9) Starch Composition 7

A starch composition 7 was obtained in the same manner as the starch composition 2 except that shortening was replaced with palm oil (iodine value: 52; solid fat content at 20° C.: 24%; solid fat content at 35° C.: 5%; water content: less than 0.1% by mass) manufactured by J-OIL MILLS.

### (2-10) Starch Composition 8

A starch composition 8 was obtained in the same manner as the starch composition 2 except that shortening was replaced with the oil and fat A prepared for the starch composition 1-3.

### (2-11) 91% Oil-and-Fat-Blended Pregelatinized Starch

Ninety-one (91) parts by mass of shortening was heated to 50° C. so as to be fiuidized, and 9 parts by mass of the pregelatinized starch 1 prepared in (1-1) was added thereto with stirring and mixed. The mixture was allowed to cool to 20° C. with stirring, thereby obtaining 91% oil-and-fat blended pregelatinized starch.

### (2-12) Margarine-Blended Pregelatinized starch

Eighty (80) parts by mass of margarine (“Meister GENERTA” manufactured by J-OIL MILLS) was heated to 50° C. so as to be fiuidized, and 20 parts by mass of the pregelatinized starch 1 prepared in (1-1) was added thereto with stirring and mixed. The mixture was allowed to cool to 20° C. with stirring, thereby obtaining a margarine-blended pregelatinized starch.

### (3) Sandwich Bread Production 1

Sandwich bread was produced in accordance with each composition shown in Table 1 according to the following procedures. Workability was evaluated by 1 worker at the time of dough preparation. Table 1 shows the results.

### (3-1) Examples 1-1 and 1-2, Comparative Examples 1-1 and 1-2

First, ingredients of dough to be mixed in advance were put into the mixer bowl of a bread mixer 1 (“VM-2” manufactured by OSHIKIRI MACHINERY LTD., 4-speed variable stage type), and the mixture was kneaded with the dough hook at the 1st speed for 3 minutes, the 2nd speed for 4 minutes, and the 3rd speed for 1 minute, thereby obtaining dough in the middle stage of mixing.

Ingredients of dough to be added later were added to the obtained dough in the middle stage of mixing, and the mixture was kneaded with the dough hook at the 1st speed for 1 minute, the 2nd speed for 3 minutes, and the 3rd speed for 4 minutes, thereby obtaining the final dough.

The final dough was taken out of the mixer bowl and fermented at 28° C. for 60 minutes, thereby obtaining primary fermented dough.

The primary fermented dough was divided into pieces each weighing 250 g, shaped into rolls, allowed to rest for 20 minutes, and then reshaped into rolls and placed in molds for 1.5 loaves such that each mold contained 3 rolls.

The primary fermented dough in each mold for 1.5 loaves was placed in a proof at 38° C. and a relative humidity of 85% for 45 minutes for final fermentation.

After the final fermentation, each dough was placed in an oven set at 210° C. and baked for 35 minutes.

After baking, the baked dough was taken out from each mold for 1.5 loaves and allowed to cool down at room temperature (20° C.), thereby obtaining sandwich bread.

### (3-2) Control Example 1

Ingredients of dough to be mixed in advance were put into the mixer bowl of the bread mixer 1, and the mixture was kneaded with the dough hook at the 1st speed for 3 minutes, the 2nd speed for 4 minutes, and the 3rd speed for 3 minutes, thereby obtaining the final dough.

The final dough was taken out of the mixer bowl and fermented at 28° C. for 60 minutes, thereby obtaining primary fermented dough.

The primary fermented dough was divided into pieces each weighing 250 g. shaped into rolls, allowed to rest for 20 minutes, and then reshaped into roils and placed in molds for 1.5 loaves such that each mold contained 3 rolls.

The primary fermented dough in each mold for 1.5 loaves was placed in a proof at 38° C. and a relative humidity of 85% for 45 minutes for final fermentation.

After the final fermentation, each dough was placed in an oven set at 210° C. and baked for 35 minutes.

After baking, the baked dough was taken out from each mold for 1.5 loaves and allowed to cool down at room temperature (20° C.), thereby obtaining sandwich bread.

The height of sandwich bread was measured with a ruler after the bread cooled down, and the highest value was determined to be the height. Regarding the appearance (baked color, shape) of the baked product, 2 expert panelists observed the bread which had cooled down and made an evaluation by consensus. The texture (softness and moist feeling) of sandwich bread was evaluated on a four-point scale according to the following evaluation criteria by the consensus of 2 expert panelists. As a control example, the one which was left for the same number of days was used. Table 1 shows the results.

### <Softness>

4. Very softer than the control example

3. Softer than the control example

2. As soft as the control example

1. Harder than the control example

### <Moist Feeling>

4. Very moist than the control example

3. More moist than the control example

2. As moist as the control example

1. More dry than the control example

TABLE 1
Evaluation based on sandwich bread (Unit: part(s) by mass)

| Ingredient | | Example | Example | Comparative | Comparative | Control |
|---|---|---|---|---|---|---|
| Type | Ingredient | 1-1 | 1-2 | Example 1-1 | Example 1-2 | Example 1 |
| Ingredient | Bread flour | 100 | 100 | 100 | 100 | 100 |
| of dough to | Bread improver | 0.1 | 0.1 | 0.1 | 0.1 | 0.1 |
| be mixed in | Superfine sugar | 4 | 4 | 4 | 4 | 4 |
| advance | Dietary salt | 2 | 2 | 2 | 2 | 2 |
| | Skim milk powder | 2 | 2 | 2 | 2 | 2 |
| | Semi-dry yeast | 1 | 1 | 1 | 1 | 1 |
| | Water | 75 | 75 | 75 | 75 | 75 |
| | Starch | | | | | 4 |
| | composition 1-1 | | | | | |
| Ingredient | Shortening | | | | 4 | |
| of dough to | 91% oil-and-fat-blended | | | 4 | | |
| be added later | pregelatinized starch | | | | | |
| | Starch | | 4 | | | |
| | composition 2 | | | | | |
| | Starch | 4 | | | | |
| | composition 1-1 | | | | | |

Evaluation

| | | | | | | |
|---|---|---|---|---|---|---|
| Workability | Stickiness | Comparable | Comparable | More sticky than | More sticky than | — |
| | of dough | to the control | to the control | the control example | the control example | |
| | | example | example | and difficult to | and difficult to | |
| | | | | work with | work with | |
| Appearance of | Height (mm) | 145 | 145 | 145 | 135 | 145 |
| baked product | Baked color | Comparable | Comparable | Lighter in baked | Comparable | — |
| | | to the control | to the control | color than the | to the control | |
| | | example | example | control example | example | |
| | Shape | Comparable | Comparable | Side shrinkage on | Comparable | — |
| | | to the control | to the control | and caving occurred | to the control | |
| | | example | example | when heat was | example | |
| | | | | dissipated compared | | |
| | | | | to the control example | | |

Texture

| | | | | | | |
|---|---|---|---|---|---|---|
| 1 day at 20° C. | Softness | 2 | 3 | 3 | 2 | — |
| after baking | Moist feeling | 3 | 3 | 2 | 1 | — |
| 2 days at 20° C. | Softness | 3 | 4 | 3 | 1 | — |
| after baking | Moist feeling | 4 | 3 | 1 | 1 | — |

The components in Table 1 are as follows.

Bread improver: “C Oriental Food” manufactured by ORIENTAL YEAST CO., LTD.

Shortening: “Facier” manufactured by J-OIL MILLS

As shown in the results in Table 1, as the starch composition containing pregelatinized starch and an edible oil and fat in a predetermined amount ratio was added to the dough in the middle stage of mixing and kneaded, the obtained sandwich bread had an excellent moist feeling as compared to the control example for which only ingredients of dough to be mixed in advance were used. In addition, sandwich bread having a soft and moist texture, in which the moist feeling was prevented from decreasing compared to the control example even after the elapse of time, was obtained.

Meanwhile, in a case in which 91% oil-and-fat blended pregelatinized starch with a high edible oil and fat content was used, sandwich bread had an insufficient moist feeling and the moist feeling decreased over time, although the obtained bread had a soft texture. In addition, the workability was extremely poor because of stickiness of the dough. Further, the obtained sandwich bread was not chewy, and caving occurred after baking, which spoiled the appearance.

Moreover, in a case in which shortening containing no pregelatinized starch was used, the obtained sandwich bread had a poor moist feeling, and therefore, the workability was poor because of stickiness of the dough.

### (4) Sandwich Bread Production 2 (Examples 2-1, 2-2, and 2-3, Comparative Example 2-1, and Control Example 2)

Sandwich bread was produced using each composition of ingredients of dough to be mixed in advance and ingredients of dough to be added later listed in Table 2. Workability was evaluated by 1 worker at the time of dough preparation. Table 2 shows the results.

First, ingredients of dough to be mixed in advance were put into the mixer bowl of a bread mixer 1, and the mixture was kneaded with the dough hook at the 1st speed for 3 minutes, the 2nd speed for 4 minutes, and the 3rd speed for 1 minute, thereby obtaining dough in the middle stage of mixing.

Ingredients of dough to be added later were added to the obtained dough in the middle stage of mixing, and the mixture was kneaded with the dough hook at the 1st speed for 1 minute, the 2nd speed for 3 minutes, and the 3rd speed for 4 minutes, thereby obtaining the final dough.

The final dough was taken out of the mixer bowl and fermented at 28° C. for 60 minutes, thereby obtaining primary fermented dough.

The primary fermented dough was divided into pieces each weighing 250 g, shaped into rolls, allowed to rest for 20 minutes, and then reshaped into rolls and placed in molds for 1.5 loaves such that each mold contained 3 rolls.

The primary fermented dough in each mold for 1.5 loaves was placed in a proof at 38° C. and a relative humidity of 85% for 45 minutes for final fermentation.

After the final fermentation, each dough was placed in an oven set at 210° C. and baked for 35 minutes.

After baking, the baked dough was taken out from each mold for 1.5 loaves and allowed to cool down at room temperature (20° C.), thereby obtaining sandwich bread.

The height of sandwich bread was measured with a ruler after the bread cooled down, and the highest value was determined to be the height. Regarding the appearance (baked color, shape) of sandwich bread, 4 expert panelists observed the bread which had cooled down and made an evaluation by consensus. The texture (softness, moist feeling, chewy feeling for the crumb, and meltability in mouth) of sandwich bread was evaluated on a four-point scale according to the following evaluation criteria by the consensus of 4 expert panelists. As a control example, the one which was left for the same number of days was used. Table 2 shows the results.

### <Softness>

4. Very softer than the control example

3. Softer than the control example

2. As soft as the control example

1. Harder than the control example

### <Moist Feeling>

4. Very moist than the control example

3. More moist than the control example

2. As moist as the control example

1. More dry than the control example

### <Chewy Feeling for the Crumb>

4. Par more excellent chewy feeling for the crumb than the control example

3. More excellent chewy feeling for the crumb than the control example

2. As the similar chewy feeling for the crumb as the control example

1. Less chewy feeling for the crumb than the control example

### <Meltability in Mouth>

4. Far more excellent meltability in mouth than the control example

3. More excellent meltability in month than the control example

2. As the similar meltability in mouth as the control example

1. Less meltability in mouth than the control example

The expression “excellent meltability in mouth” used herein means that the bread is easily mixed with saliva during chewing and is easy to swallow.

### [Table 2]

TABLE 2
Evaluation based on sandwich bread (Unit: part(s) by mass)

| Ingredient | | Example | Example | Example | Example | Comparative | Control |
|---|---|---|---|---|---|---|---|
| Type | Ingredient | 2-1 | 2-2 | 2-3 | 2-4 | Example 2-1 | Example 2 |
| Ingredient | Bread flour | 100 | 100 | 100 | 100 | 100 | 100 |
| of dough to | Bread improver | 0.1 | 0.1 | 0.1 | 0.1 | 0.1 | 0.1 |
| be mixed in | Superfine sugar | 6 | 6 | 6 | 6 | 6 | 6 |
| advance | Dietary salt | 2 | 2 | 2 | 2 | 2 | 2 |
| | Skim milk powder | 2 | 2 | 2 | 2 | 2 | 2 |
| | Semi-dry yeast | 1 | 1 | 1 | 1 | 1 | 1 |
| | Water | 73 | 73 | 73 | 73 | 73 | 73 |
| | Starch | | | | | | 4.26 |
| | composition 1-1 | | | | | | |
| Ingredient | Margarine | 15.74 | 15.74 | 13.33 | 15.74 | | 15.74 |
| of dough to | Margarine- | | | | | 20 | |
| be added later | blended | | | | | | |
| | pregelatinized | | | | | | |
| | starch | | | | | | |
| | Starch | | | | 5 | | |
| | composition 4 | | | | | | |
| | Starch | | | 6.67 | | | |
| | composition 3 | | | | | | |
| | Starch | | 5 | | | | |
| | composition 2 | | | | | | |
| | Starch | 4.26 | | | | | |
| | composition 1-1 | | | | | | |

Evaluation

| | | | | | | | |
|---|---|---|---|---|---|---|---|
| Workability | Stickiness | Comparable | Comparable | Comparable | Comparable | Comparable | — |
| | of dough | to the control | to the control | to the control | to the control | to the control | |
| | | example | example | example | example | example | |
| Appearance of | Height (mm) | 145 | 145 | 145 | 145 | 135 | 140 |
| baked product | Baked color | Comparable | Comparable | Comparable | Comparable | Comparable | — |
| | | to the control | to the control | to the control | to the control | to the control | |
| | | example | example | example | example | example | |
| | Shape | Comparable | Comparable | Comparable | Comparable | Comparable | — |
| | | to the control | to the control | to the control | to the control | to the control | |
| | | example | example | example | example | example | |

Texture

| | | | | | | | |
|---|---|---|---|---|---|---|---|
| 1 day at 20° C. | Softness | 4 | 4 | 3 | 4 | 1 | — |
| after baking | Moist feeling | 4 | 4 | 4 | 4 | 1 | — |
| | Chewy feeling | 3 | 4 | 4 | 3 | 1 | — |
| | for the crumb | | | | | | |
| | Meltability | 4 | 4 | 4 | 4 | 1 | — |
| | in mouth | | | | | | |
| 2 days at 20° C. | Softness | 3 | 4 | 3 | 4 | 1 | — |
| after baking | Moist feeling | 3 | 4 | 3 | 4 | 1 | — |
| | Chewy feeling | 4 | 4 | 4 | 3 | 1 | — |
| | for the crumb | | | | | | |
| | Meltability | 4 | 4 | 4 | 4 | 1 | — |
| | in mouth | | | | | | |

The components in Table 2 are as follows.

Bread improver: “C Oriental Food” manufactured by ORIENTAL YEAST CO., LTD.

Margarine: “Meister GENERTA” manufactured by J-OIL MILLS

As shown in the results in Table 2, as the starch composition containing pregelatinized starch and an edible oil and fat in a predetermined amount ratio was added to the dough in the middle stage of mixing and kneaded, the obtained sandwich bread puffed up and had excellent softness, moist feeling, and chewy feeling for the crumb as compared to the control example in which the starch composition was used as an ingredient of dough to be mixed in advance. In addition, sandwich bread having a favorable texture with excellent chewy feeling for the crumb and meltability in mouth, in which the texture including moist feeling was prevented from decreasing compared to the control example even after the elapse of time, was obtained. Meanwhile, in a case in which the margarine-blended pregelatinized starch was used instead of any of the starch compositions, sandwich bread did not puff up as much as the control example, resulting in the decreased texture. Sandwich bread having a favorable margarine flavor comparable to the control example was obtained by adding margarine together with any of the starch compositions.

### (5) Production of Buns (Examples 3-1 and 3-2, Comparative Examples 3-1 and 3-2, and Control Example 3)

Buns were produced using each composition of ingredients of dough to be mixed in advance and ingredients of dough to be added later listed in Table 3. Workability was evaluated by 1 worker according to the following criteria during work. Table 3 shows the results.

### <Stickiness of Dough>

4. Less sticky than the control example and very easy to work with

3. Relatively less sticky than the control example and easy to work with

2. As sticky as the control example

1. More sticky than the control example and difficult to work with

First, ingredients of dough to be mixed in advance were put into the mixer bowl of the bread mixer 1, and the mixture was kneaded with the dough hook at the 1st speed for 2 minutes and the 2nd speed for 4 minutes, thereby obtaining dough in the middle stage of mixing.

Ingredients of dough to be added later were added to the obtained dough in the middle stage of mixing, and the mixture was kneaded with the dough hook at the 1st speed for 2 minutes, the 2nd speed for 4 minutes, and the 3rd speed for 5 minutes, thereby obtaining the final dough.

The final dough was taken out of the mixer bowl and fermented at 28° C. for 50 minutes, thereby obtaining primary fermented dough.

The primary fermented dough was divided into pieces each weighing 50 g, shaped into rolls, allowed to rest for 15 minutes, and then reshaped into buns.

After reshaping, the primary fermented dough was placed in a proof at 38° C. and a relative humidity of 85% for 45 minutes for final fermentation. After the final fermentation, the dough was placed in an oven set at 200° C. and baked for 10 minutes.

After baking, the baked dough was taken out and allowed to cool down at room temperature (20° C.), thereby obtaining buns.

Regarding the appearance (baked color) of sandwich bread, 2 expert panelists observed the buns which had cooled down and made an evaluation by consensus. The texture (softness and moist feeling) of buns was evaluated on a four-point scale according to the following evaluation criteria by the consensus of 2 expert panelists. As a control example, the one which was left for the same number of days was used. Table 3 shows the results.

### <Softness>

4. Very softer than the control example

3. Softer than the control example

2. As soft as the control example

1. Harder than the control example

### <Moist Feeling>

4. Very moist than the control example

3. More moist than the control example

2. As moist as the control example

1. More dry than the control example

TABLE 3
Evaluation based on buns (Unit: part(s) by mass)

| Ingredient | | Example | Example | Comparative | Comparative | Control |
|---|---|---|---|---|---|---|
| Type | Ingredient | 3-1 | 3-2 | Example 3-1 | Example 3-2 | Example 3 |
| Ingredient | Bread flour | 100 | 100 | 100 | 100 | 100 |
| of dough to | Bread improver | 0.1 | 0.1 | 0.1 | 0.1 | 0.1 |
| be mixed in | Superfine sugar | 10 | 10 | 10 | 10 | 10 |
| advance | Dietary salt | 1.8 | 1.8 | 1.8 | 1.8 | 1.8 |
| | Skim milk powder | 3 | 3 | 3 | 3 | 3 |
| | Whole egg | 5 | 5 | 5 | 5 | 5 |
| | Semi-dry yeast | 1.2 | 1.2 | 1.2 | 1.2 | 1.2 |
| | Water | 66 | 66 | 66 | 66 | 66 |
| | Statch | | | | | 3.19 |
| | composition 1-1 | | | | | |
| | Starch | | | 3.75 | | |
| | composition 2 | | | | | |
| Ingredient | Shortening | 9.81 | 9.25 | 9.25 | 10 | 9.81 |
| of dough to | Starch | | 3.75 | | | |
| be added later | composition 2 | | | | | |
| | Pregelatinized | | | | 3 | |
| | starch | | | | | |
| | Starch | 3.19 | | | | |
| | composition 1-1 | | | | | |

Evaluation

| | | | | | | |
|---|---|---|---|---|---|---|
| Workability | Stickiness | 4 | 3 | 2 | 1 | — |
| | of dough | | | | | |
| Appearance of | Baked color | Comparable | Comparable | Comparable | Lighter than | — |
| baked product | | to the control | to the control | to the control | the control | |
| | | example | example | example | example | |

Texture

| | | | | | | |
|---|---|---|---|---|---|---|
| 1 day at 20° C. | Softness | 4 | 4 | 1 | 3 | — |
| after baking | Moist feeling | 4 | 4 | 2 | 4 | — |
| 2 days at 20° C. | Softness | 3 | 3 | 1 | 3 | — |
| after baking | Moist feeling | 3 | 4 | 1 | 2 | — |

The components in Table 3 are as follows.

Bread improver: “C Oriental Food” manufactured by ORIENTAL YEAST CO., LTD.

Shortening: “Facier” manufactured by J-OIL MILLS

As shown in the results in Table 3, as the starch composition containing pregelatinized starch and an edible oil and fat in a predetermined amount ratio was added to the dough in the middle stage of mixing and kneaded, stickiness of dough was reduced as compared to the control example in which the starch composition was used as an ingredient of dough to be mixed in advance. The buns of the Examples had excellent softness and moist feeling. In addition, buns having a favorable texture with softness and moist feeling, in which the texture including moist feeling was prevented from decreasing compared to the control example even after the elapse of time, was obtained.

Meanwhile, in a case in which the starch composition 2 was used as an ingredient of dough to be mixed in advance, the dough became sticky which made it difficult to work therewith, the obtained buns had a hard and dry texture.

In addition, in a case in which the pregelatinized starch containing no oil and fat was used, the dough became sticky which resulted in very poor workability, and the moist feeling of the obtained buns was not prevented from decreasing.

### (6) Production of Sweet Rolls (Example 4, Comparative Example 4, and Control Example 4)

Sweet rolls were produced using each composition of ingredients of sponge dough, ingredients of dough to be mixed in advance, and ingredients of dough to be added later listed in Table 4. Workability was evaluated by 1 worker according to the following criteria during work. Table 4 shows the results.

### <Stickiness of Dough>

4. Less sticky than the control example and very easy to work with

3. Relatively less sticky than the control example and easy to work with

2. As sticky as the control example

1. More sticky than the control example and difficult to work with

First, ingredients of sponge dough were put into the mixer bowl of the bread mixer 1, and the mixture was kneaded with the dough hook at the 1st speed for 3 minutes and the 2nd speed for 1 minute, and the mixture was taken out of the mixer bowl and fermented at 27° C. for 120 minutes, thereby obtaining sponge dough.

Next, ingredients of dough to be mixed in advance and the sponge dough were put into the mixer bowl of the bread mixer 1, and the mixture was kneaded with the dough hook at the 1st speed for 3 minutes and the 2nd speed for 3 minutes, thereby obtaining dough in the middle stage of mixing.

Ingredients of dough to be added later were added to the obtained dough in the middle stage of mixing, arid the mixture was kneaded with the dough hook at the 1st speed for 1 minute, the 2nd speed for 2 minutes, and the 3rd speed for 1 minute, thereby obtaining the final dough.

The final dough was taken out of the mixer bowl and fermented at 27° C. for 30 minutes, thereby obtaining primary fermented dough.

The primary fermented dough was divided into pieces each weighing 45 g, shaped into rolls, allowed to rest for 15 minutes, and then reshaped into sweet rolls.

After reshaping, the primary fermented dough was placed in a proof at 38° C. arid a relative humidity of 80% for 50 minutes for final fermentation.

After the final fermentation, the dough was placed in an oven set at 200° C./200° C. (upper rack/lower rack) and baked for 10 minutes.

After baking, the baked dough was taken out and allowed to cool down at room temperature (20° C.), thereby obtaining sweet rolls.

Regarding the appearance (baked color) of sandwich bread, 2 expert panelists observed the sweet rolls which had cooled down and made an evaluation by consensus. The texture (softness and moist feeling) of sweet rolls was evaluated on a four-point scale according to the following evaluation criteria by the consensus of 2 expert panelists. As a control example, the one which was left for the same number of days was used. Table 4 shows the results.

### <Softness>

4. Very softer than the control example

3. Softer than the control example

2. As soft as the control example

1. Harder than the control example

### <Moist Feeling>

4. Very moist than the control example

3. More moist than the control example

2. As moist as the control example

1. More dry than the control example

TABLE 4
Evaluation based on sweet rolls (Unit: part(s) by mass)

| Ingredient | | | Comparative | Control |
|---|---|---|---|---|
| Type | Ingredient | Example 4 | Example 4 | Example 4 |
| Ingredient | Bread flour | 70 | 70 | 70 |
| of sponge | Bread improver | 0.1 | 0.1 | 0.1 |
| dough | Superfine sugar | 5 | 5 | 5 |
| | Semi-dry yeast | 1.2 | 1.2 | 1.2 |
| | Whole egg | 10 | 10 | 10 |
| | Water | 32 | 32 | 32 |
| Ingredient | Bread flour | 30 | 30 | 30 |
| of dough to | Superfine sugar | 20 | 20 | 20 |
| be mixed in | Dietary salt | 0.8 | 0.8 | 0.8 |
| advance | Skim milk powder | 2 | 2 | 2 |
| | Water | 30 | 18 | 30 |
| | Starch | | | 10 |
| | composition 3 | | | |
| Ingredient | Margarine | 10 | 10 | 10 |
| of dough to | Starch | 10 | | |
| be added later | composition 3 | | | |

Evaluation

| | | | | |
|---|---|---|---|---|
| Workability | Stickiness | 4 | 4 | — |
| | of dough | | | |
| Appearance of | Baked color | Favorable with | Favorable with | — |
| baked product | | darker baked | darker baked | |
| | | color than the | color than the | |
| | | control example | control example | |

Texture

| | | | | |
|---|---|---|---|---|
| 1 day at 20° C. | Softness | 3 | 1 | — |
| after baking | Moist feeling | 3 | 1 | — |
| 2 days at 20° C. | Softness | 4 | 1 | — |
| after baking | Moist feeling | 4 | 1 | — |

The components in Table 4 are as follows.

Bread improver: “C Oriental Food” manufactured by ORIENTAL YEAST CO., LTD.

Margarine: “Meister GENERTA” manufactured by J-OIL MILLS

As shown in the results in Table 4, as the starch composition containing pregelatinized starch and an edible oil and fat in a predetermined amount ratio was added to the dough in the middle stage of mixing and kneaded, the sweet rolls of the Examples had excellent softness and moist feeling as compared to the control example for which only ingredients of dough to be mixed in advance were used. In addition, sweet rolls having a favorable texture with softness and moist feeling, in which the texture including moist feeling was prevented from decreasing compared to the control example even after the elapse of time, was obtained.

Meanwhile, in a case in which the starch composition 3 was not used, the obtained sweet rolls had a hard and dry texture.

### (7) Production of doughnuts (Examples 5-1 and 5-2, Comparative Example 5)

Doughnuts were produced using each composition of ingredients of dough to be mixed in advance and ingredients of dough to be added later listed in Table 5.

TABLE 5
Evaluation based on doughnuts (Unit: part(s) by mass)

| Ingredient | | Example | Example | Comparative |
|---|---|---|---|---|
| Type | Ingredient | 5-1 | 5-2 | Example 5 |
| Ingredient | Bread flour | 70 | 70 | 70 |
| of dough to | Cake flour | 30 | 30 | 30 |
| be mixed in | Bread improver | 0.2 | 0.2 | 0.2 |
| advance | Baking powder | 1 | 1 | 1 |
| | Superfine sugar | 15 | 15 | 15 |
| | Dietary salt | 1.4 | 1.4 | 1.4 |
| | Skim milk powder | 3 | 3 | 3 |
| | Whole egg | 10 | 10 | 10 |
| | Semi-dry yeast | 2 | 2 | 2 |
| | Water | 53 | 56 | 50 |
| Ingredient | Shortening | 10 | 10 | 10 |
| of dough to | Starch | | 6 | |
| be added later | composition 5 | | | |
| | Starch | 3 | | |
| | composition 1-2 | | | |

The components in Table 5 are as follows.

Bread improver: “C Oriental Food” manufactured by ORIENTAL YEAST CO., LTD.

Shortening: “Facier” manufactured by J-OIL MILLS

First, ingredients of dough to be mixed in advance were put into the mixer bowl of the bread mixer 1. and the mixture was kneaded with the dough hook at the 1st speed for 3 minutes and the 2nd speed for 3 minutes, thereby obtaining dough in the middle stage of mixing.

Ingredients of dough to be added later were added to the obtained dough in the middle stage of mixing, and the mixture was kneaded with the dough hook at the 1st speed for 2 minutes and the 2nd speed for 5 minutes, thereby obtaining the final dough.

The final dough was taken out of the mixer bowl and fermented at 27° C. for 30 minutes, thereby obtaining primary fermented dough.

The primary fermented dough was divided into pieces each weighing 40 g, shaped into rolls, allowed to rest for 20 minutes, and then reshaped into doughnuts.

After reshaping, the primary fermented dough was placed in a proof at 40° C. and a relative humidity of 65% for 30 minutes for final fermentation.

After the final fermentation, the bench time was set to 1 minute, and then the dough was deep-fried in oil using a frying oil heated to 180° C. (“J Fry Up 301” manufactured by J-OIL MILLS) for 4 minutes.

The dough deep-fried in oil was allowed to cool down at room temperature (20° C.), thereby obtaining doughnuts.

Workability was evaluated by 1 worker during work. There was no problem in both the Examples and Comparative Examples.

The texture (softness and moist feeling) of the doughnuts was evaluated on the day after deep-frying in oil and after 2 days at 20° C. after deep-frying in oil by the consensus of 2 expert panelists.

As a result, on the day after deep-frying in oil. the doughnuts of Comparative Example 5 had a hard and compressed texture, while on the other hand, the doughnuts of Example 5-1 had an excellent soft and fluffy texture with favorable chewiness. In addition, the doughnuts of Example 5-2 had an appropriate elastic texture and excellent meltability in mouth.

Two days after deep-frying in oil, the doughnuts of Comparative Example 5 had a hard and non-elastic texture, while on the other hand, the doughnuts of Example 5-1 maintained an excellent soft and crispy texture. In addition, the doughnuts of Example 5-2 had excellent meltability in mouth and maintained a soft texture. Further, the doughnuts of both Examples 5-1 and 5-2 maintained a moist feeling as compared to Comparative Example 5.

### (8) Production of Rice Flour Bread (Example 6, Comparative Example 6)

Rice flour bread was produced using each composition of ingredients of dough to be mixed in advance and ingredients of dough to be added later listed in Table 6.

TABLE 6
Evaluation based on rice flour bread (Unit: part(s) by mass)

| Ingredient | | | Comparative |
|---|---|---|---|
| Type | Ingredient | Example 6 | Example 6 |
| Ingredient | Rice flour | 100 | 100 |
| of dough to | Vital wheat gluten | 20 | 20 |
| be mixed in | Bread improver | 0.2 | 0.2 |
| advance | Superfine sugar | 8 | 8 |
| | Dietary salt | 1.8 | 1.8 |
| | Skim milk powder | 3 | 3 |
| | Rapeseed oil | 2 | 3 |
| | Semi-dry yeast | 1.6 | 1.6 |
| | Water | 106 | 100 |
| Ingredient | Margarine | 3 | 3 |
| of dough to | Starch | 4 | |
| be added later | composition 7 | | |

The components in Table 6 are as follows.

Bread improver: “C Oriental Food” manufactured by ORIENTAL YEAST CO., LTD.

Margarine: “Metster GENERTA” manufactured by J-OIL MILLS

First, ingredients of dough to be mixed in advance were put into the mixer bowl of a bread mixer 1, and the mixture was kneaded with the dough hook at the 1st speed for 8 minutes, the 2nd speed for 8 minutes, and the 3rd speed for 2 minutes, thereby obtaining dough in the middle stage of mixing.

Ingredients of dough to be added later were added to the obtained dough in the middle stage of mixing, and the mixture was kneaded with the dough hook at the 1st speed for 1 minute, the 2nd speed for 3 minutes, and the 3rd speed for 4 minutes, thereby obtaining the final dough.

The final dough was taken out of the mixer bowl and fermented at 28° C. for 60 minutes, thereby obtaining primary fermented dough.

The primary fermented dough was divided into pieces each weighing 50 g, shaped into rolls, allowed to rest for 20 minutes, and then reshaped into sweet red bean buns (Anpan) each wrapping 30 g of sweet red bean paste.

After reshaping, the primary fermented dough was placed in a proof at 38° C. and a relative humidity of 85% for 50 minutes for final fermentation. After the final fermentation, the dough was placed in an oven set at 200° C./200° C. (upper rack/lower rack) and baked for 13 minutes.

After baking, the baked dough was allowed to cool down at room temperature (20° C.), thereby obtaining rice flour bread.

The texture (softness and moist feeling) of rice flour bread was evaluated after 1 day at 20° C. after baking and after 2 days at 20° C. after baking by the consensus of 2 expert panelists.

As a result, 1 day after baking, the rice flour bread of Comparative Example 6 had a powdery and hard texture, while on the other hand, the rice flour bread of Example 6 had a soft and moist texture.

Two (2) days after baking, the rice flour bread of Comparative Example 6 had a hard and dry texture, while on the other hand, the rice flour bread of Example 6 had a soft and moist texture as compared to the rice flour bread of Comparative Example 6.

### (9) Production of Chinese steamed buns (Example 7, Comparative Example 7)

Chinese steamed buns were produced using each composition of ingredients of dough to be mixed in advance and ingredients of dough to be added later listed in Table 7.

TABLE 7
Evaluation based on Chinese steamed buns (Unit: part(s) by mass)

| Ingredient | | | Comparative |
|---|---|---|---|
| Type | Ingredient | Example 7 | Example 7 |
| Ingredient | Bread flour | 550 | 50 |
| of dough to | Cake flour | 50 | 50 |
| be mixed in | Baking powder | 1 | 1 |
| advance | Dietary salt | 1 | 1 |
| | Superfine sugar | 10 | 10 |
| | Semi-dry yeast | 0.8 | 0.8 |
| | Evaporated milk | 8 | 8 |
| | Water | 52 | 46 |
| Ingredient | Shortening | 3 | 3 |
| of dough to | Starch | 4 | |
| be added later | composition 8 | | |

The components in Table 7 are as follows.

Shortening: “Facier” manufactured by J-OIL MILLS

First, ingredients of dough to be mixed in advance were put into the mixer bowl of the bread mixer 1. and the mixture was kneaded with the dough hook at the 1st speed for 4 minutes and the 2nd speed for 1 minute, thereby obtaining dough in the middle stage of mixing.

Ingredients of dough to be added later were added to the obtained dough in the middle stage of mixing, and the mixture was kneaded with the dough hook at the 1st speed for 9 minutes and the 3rd speed for 2 minutes, thereby obtaining the final dough.

The final dough was taken out of the mixer bowl and fermented at 28° C. for 10 minutes, thereby obtaining primary fermented dough.

The primary fermented dough was divided into pieces each weighing 50 g, shaped into rolls, allowed to rest for 10 minutes, and then reshaped into steamed bean jam buns each wrapping 30 g of steamed bean jam.

After reshaping, the primary fermented dough was placed in a proof at 40° C. and a relative humidity of 50% for 20 minutes for final fermentation.

After the final fermentation, the dough was placed in a convection oven set at 99° C. for low-temperature steam and steamed for 10 minutes.

The steamed dough was allowed to cool down at room temperature (20° C.), thereby obtaining Chinese steamed buns.

The texture (softness and moist feeling) of Chinese steamed buns was evaluated immediately after production and after storage in a refrigerator at 4° C. for 2 days following production and reheating in a microwave by the consensus of 2 expert panelists.

As a result, immediately after production, the Chinese steamed buns of Example 7 had softness and chewy feeling for the crumb as compared to those of Comparative Example 7.

Even 2 days after production, the Chinese steamed buns of Example 7 maintained softness and chewy feeling for the crumb as compared to those of Comparative Example 7.

### (10) Production of Danish Pastry (10) (Example 8, Comparative Example 8)

Danish pastry was produced using each composition of ingredients of dough to be mixed in advance and ingredients of dough to be added later listed in Table 8.

TABLE 8
Evaluation based on Danish pastry (Unit: part(s) by mass)

| Ingredient | | | Comparative |
|---|---|---|---|
| Type | Ingredient | Example 8 | Example 8 |
| Ingredient | Bread flour | 80 | 80 |
| of dough to | Cake flour | 20 | 20 |
| be mixed in | Superfine sugar | 10 | 10 |
| advance | Dietary salt | 1.5 | 1.5 |
| | Skim milk powder | 3 | 3 |
| | Compressed yeast | 5 | 5 |
| | Whole egg | 6 | 6 |
| | Water | 50 | 47 |
| Ingredient | Shortening | 8 | 8 |
| of dough to | Starch | 3 | |
| be added later | composition 1-2 | | |

The components in Table 8 are as follows.

Shortening: “Facier” manufactured by J-OIL MILLS

First, ingredients of dough to be mixed in advance were put into the mixer bowl of a bread mixer 2 (“HP-20M” manufactured by KANTO KONGOKI INDUSTRIAL Co, Ltd.), and the mixture was kneaded with the dough hook at the 1st speed for 3 minutes and the 2nd speed for 1 minute, thereby obtaining dough in the middle stage of mixing.

Ingredients of dough to be added later were added to the obtained dough in the middle stage of mixing, and the mixture was kneaded with the dough hook at the 2nd speed for 3 minutes, thereby obtaining the final dough.

The final dough was taken out of the mixer howl, divided into pieces each weighing 1800 g, and fermented at 20° C. for 20 minutes. Thereafter, the dough was cooled at −5° C., thereby obtaining primary fermented dough.

Five hundred (500) g of a margarine sheet (“Meister GENERTA sheet” manufactured by J-OIL MILLS) was mixed into the cooled primary fermented dough in such a way to form layers. The dough was folded in three twice, allowed to rest at −5° C. for 1 hour, further folded in three once, and allowed to rest at −5° C. for 1 hour, thereby obtaining Danish pastry dough.

This Danish pastry dough was stretched to a thickness of 3 mm, cut into 8 cm×10 cm, and quickly frozen.

The frozen dough was stored at −18° C. for a predetermined number of days and thawed at room temperature, and then the dough was placed in a proof at 30° C. and a relative humidity of 75% for 45 minutes for final fermentation.

After the final fermentation, the dough was placed in an oven set at 200° C./200° C. (upper rack/lower rack) and baked for 12 minutes.

After baking, the baked dough was allowed to cool down at room temperature (20° C.), thereby obtaining Danish pastry.

The texture (softness, moist feeling, crispy texture) of Danish pastry in a case in which the dough was baked after 3 days of freezing and in a case in which the dough was baked after 5 weeks of freezing was evaluated by the consensus of 2 expert panelists.

As a result, in a case in which the dough was baked after 3 days of freezing, the Danish pastry of Example 8 had a favorable fluffy and crispy light texture on the day of baking. In this case, after 1 day at 20° C. after baking, the Danish pastry of Comparative Example 8 had a hard and poor crispy texture, while on the other hand, the Danish pastry of Example 8 maintained a soft and fluffy texture with a moist feeling as compared to the Danish pastry of Comparative Example 8.

In a case in which the dough was baked after 5 weeks of freezing, the Danish pastry of Comparative Example 8 had poor rising and flat appearance, and a hard and poor crispy texture was felt even on the day of baking. In contrast, the Danish pastry of Example 8 maintained the volume comparable to that in a case in which the dough was baked after 3 days of freezing, and also maintained a crispy texture and a moist feeling appropriate for Danish pastry.

### (11) Production of Plain Pizza (Examples 9-1 and 9-2, Comparative Example 9)

Plain pizza was produced using each composition of ingredients of dough to be mixed in advance and ingredients of dough to be added later listed in Table 9.

TABLE 9
Evaluation based on plain pizza (Unit: part(s) by mass)

| Ingredient | | Example | Example | Comparative |
|---|---|---|---|---|
| Type | Ingredient | 9-1 | 9-2 | Example 9 |
| Ingredient | Bread flour | 50 | 50 | 50 |
| of dough to | Cake flour | 50 | 50 | 50 |
| be mixed in | Dietary salt | 2 | 2 | 2 |
| advance | Semi-dry yeast | 0.4 | 0.4 | 0.4 |
| | Water | 72 | 60 | 58 |
| Ingredient | Rapeseed oil | 5 | 5 | 5 |
| of dough to | Starch | 15 | | |
| be added later | composition 6 | | | |
| | Starch | | 2 | |
| | composition 1-3 | | | |

First, ingredients of dough to be mixed in advance were put into the mixer bowl of the bread mixer 1, and the mixture was kneaded with the dough hook at the 1st speed for 5 minutes and the 2nd speed for 5 minutes, thereby obtaining dough in the middle stage of mixing.

Ingredients of dough to be added later were added to the obtained dough in the middle stage of mixing, and the mixture was kneaded with the dough hook at the 1st speed for 2 minutes and the 3rd speed for 3 minutes, thereby obtaining the final dough.

The final dough was taken out of the mixer bowl and fermented at 27° C. for 120 minutes, thereby obtaining primary fermented dough.

The primary fermented dough was divided into pieces each weighing 100 g, shaped into rolls, allowed to rest for 30 minutes, and then reshaped into pizza.

After reshaping, the primary fermented dough was placed in a proof at 35° C. and a relative humidity of 85% for 30 minutes for final fermentation. After the final fermentation, the dough was placed in an oven set at 250° C./250° C. (upper rack/lower rack) and baked for 6 minutes, thereby obtaining plain pizza.

The prepared plain pizza was allowed to cool down at room temperature (20° C.), and stored in a refrigerator at 4° C. for a predetermined number of days.

Each plain pizza after storage was baked in a 1000 W toaster for 1 minute and evaluated.

The texture (softness, moist feeling, chewy feeling for the crumb) in a case in which the plain pizza was baked after 1 day of refrigeration and in a case in which the plain pizza was baked after 2 weeks of refrigeration was evaluated by the consensus of 2 expert panelists.

As a result, in a case in which the plain pizza was baked after 1 day of refrigeration, the plain pizza of Example 9-1 was very soft and fluffy. In addition, the plain pizza of Example 9-2 had a soft texture, a moist feeling and a chewy feeling for the crumb appropriate for pizza.

In a case in which the plain pizza was baked after 2 weeks of refrigeration, the plain pizza of Comparative Example 9 had a hard and poor crispy texture, and also had a dry texture and a staling property. In contrast, the plain pizza of Example 9-1 maintained softness and a fluffy texture. In addition, the plain pizza of Example 9-2 maintained a moist feeling and a chewy feeling for the crumb.

1. A production method for dough for breads, the method comprising:
preparing a starch composition containing 50% by mass to 97% by mass of pregelatinized starch and 3% by mass to 50% by mass of an edible oil and fat;
adding the starch composition to the dough in a middle stage of mixing; and
further kneading the dough in the middle stage of mixing to which the starch composition is added.

2. The production method according to claim 1, wherein the starch composition is obtained by pregelatinizing a starch slurry containing the edible oil and fat.

3. The production method according to claim 1, wherein the starch composition is obtained by mixing the pregelatinized starch and the edible oil and fat.

4. The production method according to claim 1, wherein the amount of the starch composition added is 1 part by mass to 20 parts by mass with respect to 100 parts by mass of the total amount of flour in the dough for breads.

5. The production method according to claim 1, further comprising adding an oil-and-fat composition to the dough in the middle stage of mixing.

6. The production method according to claim 5, wherein the oil-and-fat composition is a water-in-oil emulsified oil-and-fat composition.

7. The production method according to claim 5, wherein the amount of the oil-and-fat composition added is 1 part by mass to 100 parts by mass with respect to 100 parts by mass of the total amount of flour in the dough for breads.

8. A production method for breads, the method comprising: heating the dough for breads obtained by the production method according to claim 1.

9. A method for preventing a moist feeling of breads from decreasing, the method is characterized by adding a starch composition containing 50% by mass to 97% by mass of pregelatinized starch and 3% by mass to 50% by mass of an edible oil and fat to dough in a middle stage of mixing in obtaining dough for the breads.

10. A starch composition to be added to dough in a middle stage of mixing in producing dough for breads, the composition comprising 50% by mass to 97% by mass of pregelatinized starch and 3% by mass to 50% by mass of an edible oil and fat.
